(19) United States
(12) Patent Application Publication
(10) Pub. No.: US 2023/0076583 A1
(43) Pub. Date: Mar. 9, 2023

(54) POLYIMIDE PRECURSOR SOLUTION, POROUS POLYIMIDE FILM, AND INSULATED WIRE

(71) Applicant: FUJIFILM Business Innovation Corp., Tokyo (JP)

(72) Inventors: Kosuke NAKADA, Kanagawa (JP); Shigeru SEITOKU, Kanagawa (JP); Takeshi IWANAGA, Kanagawa (JP); Hidekazu HIROSE, Kanagawa (JP)

(73) Assignee: FUJIFILM Business Innovation Corp., Tokyo (JP)

(21) Appl. No.: 17/592,084

(22) Filed: Feb. 3, 2022

(30) Foreign Application Priority Data
Aug. 31, 2021 (JP) 2021-141529

(51) Int. Cl. C08G 73/10; C09D 179/08

(52) U.S. Cl. CPC C08G 73/1067; C09D 179/08

(57) ABSTRACT

A polyimide precursor solution includes: a polyimide precursor that is a polymer of a tetracarboxylic dianhydride and a diamine compound; particles; a solvent; and a compound having at least four carboxy groups per molecule.

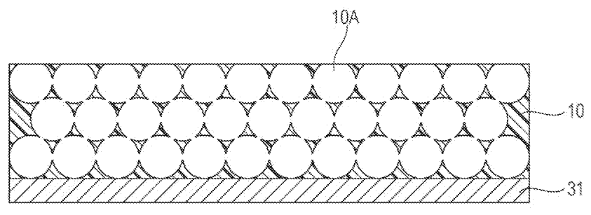

### CROSS-REFERENCE TO RELATED APPLICATIONS

This application is based on and claims priority under 35 USC 119 from Japanese Patent Application No. 2021-141529 filed Aug. 31, 2021.

### BACKGROUND

### (i) Technical Field

The present disclosure relates to a polyimide precursor solution, a porous polyimide film, and an insulated wire.

### (ii) Related Art

International Publication No. WO2018/230706 discloses an insulated wire including a linear conductor and an insulating coating disposed so as to surround the outer circumferential surface of the conductor. The insulating coating includes a polyimide layer having a molecular structure including specific repeating units at a specific molar ratio, and the polyimide layer has a plurality of pores at a specific ratio.

Japanese Unexamined Patent Application Publication No. 2017-45662 discloses an insulated wire including a linear conductor and one or a plurality of insulating layers stacked on the outer circumferential surface of the conductor. At least one of the insulating layers contains a plurality of hollow inorganic particles, and the compressive strength of the inorganic particles measured by a glycerol method according to ASTM D3102-78 is 10 MPa or more.

### SUMMARY

A polyimide film used as an insulating coating of an insulated wire is required. to have a low dielectric constant in order to increase the corona discharge start voltage of the wire. In one example of a method for obtaining a polyimide film having a low delectric constant, the polyimide film is made porous, and the porosity of the polyimide film is increased.

However, when the porosity of the porous polyimide film is increased in order to reduce its dielectric constant, the mechanical strength of the polyimide film itself may decrease.

Aspects of non-limiting embodiments of the present disclosure relate to a polyimide precursor solution that can be used to form a porous polyimide film that has a lower dielectric constant and higher mechanical strength than when a polyimide precursor solution containing only a polyimide precursor, particles, and a solvent is used.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a polyimide precursor solution including: a polyimide precursor that is a polymer of a tetracarboxylic dianhydride and a diamine compound; particles; a solvent; and a compound having at least four carboxy groups per molecule.

### BRIEF DESCRIPTION OF THE DRAWING

Exemplary embodiments of the present disclosure will be described in detail based on the following FIGURE, wherein:

The FIGURE is a schematic illustration showing the form of a porous polyimide film obtained using a polyimide precursor solution in an exemplary embodiment.

### DETAILED DESCRIPTION

A description will be given of exemplary embodiments of the present disclosure. The description and Examples are illustrative of the exemplary embodiments and are not intended to limit the scope of the exemplary embodiments.

In a set of numerical ranges expressed in a stepwise manner in the present specification, the upper or lower limit in one numerical range may be replaced with the upper or lower limit in another numerical range in the set. Moreover, in a numerical range described in the present specification, the upper or lower limit. in the numerical range may be replaced with a value indicated in an Example.

In the present specification, the term “step” is meant to include not only an independent step but also a step that is not clearly distinguished from other steps so long as the prescribed purpose of the step can be achieved.

Any component may include a plurality of materials corresponding to the component.

When reference is made to the amount of a component in a composition, if the composition contains a plurality of materials corresponding to the component, the amount means the total amount of the plurality of materials, unless otherwise specified.

In the exemplary embodiments, the term “film” is a concept that encompasses not only components generally referred to as “films” but also components generally referred to as “membranes” and “sheets.”

### [Polyimide Precursor Solution]

A polyimide precursor solution according to an exemplary embodiment contains: a polyimide precursor that is a polymer of a tetracarboxylic dianhydride and a diamine compound; particles; a solvent; and a compound having at least four carboxy groups per molecule (hereinafter referred to also as a “specific compound”).

With the polyimide precursor solution according to the present exemplary embodiment having the above-described structure, a porous polyimide film having both a low dielectric constant and high mechanical strength can be obtained. The reason for this is unclear but may be as follows.

As described above, in one example of the method for obtaining a polyimide film having a low dielectric constant, the polyimide film is made porous, and the porosity of the polyimide film is increased. However, when the porosity of the porous polyimide film is increased in order to reduce its dielectric constant, the mechanical strength of the polyimide film itself may decrease.

However, in the present exemplary embodiment, the polyimide precursor solution contains the specific compound. The specific compound has at least four non-dehydrated carboxy groups per molecule.

A porous polyimide film is produbed, for example, by applying a polyimide precursor solution to a substrate to form a coating, drying the coating to form a film, and firing (i.e., imidizing) the film to remove the particles.

The specific compound may be dehydrated when carboxy groups are dehydrated during firing of the film and thereby converted to a carboxylic anhydride. The anhydride obtained by dehydrating the specific compound may react with units derived from the diamine in the polyimide precursor to thereby form a crosslinked structure. Specifically, the specific compound serves as a crosslinking agent, so that the mechanical strength is high even when the porosity is high. This allows the porous polyimide film to be obtained to have both a low dielectric constant and high mechanical strength.

Components contained in the polyimide precursor solution according to the present exemplary embodiment will be described.

### <Polyimide Precursor>

The polyimide precursor solution in the present exemplary embodiment contains the polyimide precursor that is a polymer of a tetracarboxylic dianhydride and a diamine compound. The polyimide precursor is, for example, a polymer prepared by polymerizing a tetracarboxylic dianhydride and a diamine compound at a molar ratio of 1:1 and includes a unit derived from the tetracarboxylic dianhydride and a unit derived from the diamine compound.

Examples of the polyimide precursor include a resin (polyimide precursor) having a repeating unit represented by general formula (I).

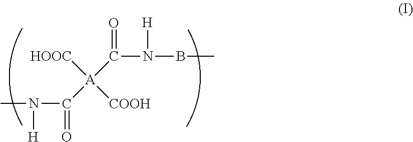

(In general formula (I), A represents a tetravalent organic group, and B represents a divalent organic group.)

In general formula (I), the tetravalent organic group represented by A is a residue obtained by removing four carboxyl groups from the tetracarboxylic dianhydride used as a raw material.

The divalent organic group represented by B is a residue obtained by removing two amino groups from the diamine compound used as a raw material.

Specifically, the polyimide precursor having the repeating unit represented by general formula (I) is a polymer of a tetracarboxylic dianhydride and a ddamine compound.

Examples of the tetracarboxylic dianhydride include aromatic compounds and aliphatic compounds. From the viewpoint of obtaining a porous polyimide film having high mechanical strength, the tetracarboxylic dianhydride may be an aromatic compound. Specifically, in general formula (I), the tetravalent organic group represented by A may be an aromatic organic group.

Examples of the aromatic tetracarboxylic dianhydride include pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′,4,4′-biphenylethertetracarboxylic dianhydride, 3,3′,4,4′-dimethyldiphenylsilanetetracarboxylic dianhydride 3,3′,4,4′-tetraphenylsilanetetracarboxylic dianhydride,, 1,2,3,4-furantetracarboxylic dianhydride, 4,4′-bis(3,4-dicarboxyphenoxy)diphenylsuifide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidenediphthalic dianhydride, 3,3′,4,4′-biphenyltetracarboxylic dianhydride, 2,3,3′,4′-biphenyltetracarboxylic dianhydride, bis(phthalic acid)phenylphosphine oxide dianhydride, p-phenylene-bis(triphenylphthalic)dianhydride, m-phenylene-bis(triphenylphthalic)dianhydride, bis(triphenylphthalic acid)-4,4′-diphenyl ether dianhydride, bis(triphenylphthalic acid)-4,4′-diphenylmethane dianhydxide, 1,3,3a,4,5,9b-hexahydro-2,5-dioxo-3-furanyl)-naphtho[1,2-c]furan-1,3-dione, 1,3,3a,4,5,9b-hexahydro-5-methyl-5-(tetrahydro-2,5-dioxo furanyl)-naphtho[1,2-c]furan-1,3-dione, and 1,3,3a,4,5,9b-hexahydro-8-methyl-5-(tetrahydro-2,5-dioxo-3-furanyl)naphtho[1,2-c]furan-1,3-dione,

Examples of the aliphatic tetracarboxylic dianhydride include butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic dianhydride, tricarboxynorbornane-2-acetic dianhydride, 2,3,4,5-tetrahydrofurantetracarboxylic dianhydride, 5-(2,5-dioxotetrahydrofuryl)-3-methyl-3-cyclohexene-1, dicarboxylic dianhydride, and bicyclo[2,2,2]-oct-7-ene-2,3,5,6-tetracarboxylic dianhydride.

Of these, the tetracarboxylic dianhydride may be an aromatic tetracarboxylic dianhydride. Specifically, the tetracarboxylic dianhydride is, for example, preferably pyromeilitic dianhydride, 3,3′,4,4′-biphenyltetracarboxylic dianhydride, 2,3,3′,4′-biphenyltetracarboxylic dianhydxide, 3,3′,4,4′-biphenylethertetracarboxylic dianhydride, or 3,3′,4,4′-benzophenonetetracarboxylic dianhydride, more preferably pyromellitic dianhydride, 3,3′,4,4′-biphenyltetracarboxylic dianhydride, or 3,3′,4,4′-benzophenonetetracarboxylic dianhydride, and particularly preferably 3,3′,4,4′-biphenyltetracarboxylic dianhydride.

One tetracarboxylic dianhydride may be used alone, or two or more tetracarboxylic dianhydrides may be used in combination.

When two or more tetracarboxylic dianhydrides are used in combination, a combination of aromatic tetracarboxylic dianhydrides or a combination of aliphatic tetracarboxylic acids may be used, or a combination of an aromatic tetracarboxylic dianhydride and an aliphatic tetracarboxylic dianhydride may be used.

The diamine compound has two amino groups in its molecular structure. Examples of the diamine compound include aromatic compounds and aliphatic compounds. From the viewpoint of obtaining a porous polymide film having high mechanical strength, the diamine compound may be an aromatic compound. Specifically, the divalent organic group represented by B in general formula (I) may be an aromatic organic group.

Examples of the diamine compound include: aromatic diamines such as p-phenyleneddamine, m-phenvienediamine, 4,4′-diaminodiphenylmethane, 4,4′-ddaminodiphenylethane, 4,4′-diaminodiphenyl ether, 4,4′-diaminodiphenyl sulfide, 4,4′-diamnodiphenylsulfone, 1,5-diaminonaphthalene, 3,3-dimethyl-4,4′-diaminobiphenyl, 5-amino-1-(4′-amihophenyl)-1,3,3-trimethylindan, 6-amino-1-(4′-aminophenyl)-1,3,3-trimethylindan, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trfluoromethyl)biphenyl, 2,2-bis[4-(4-aminophenoxy)phenyl]propane, 2,2-bis[4-(aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisanillne, 4,4′-(m-phenyleneisopropylidene)bisanillne, 2,2′-bis[4-(4-amino-2-trifluoromethylphenoxy)phenyl]hexafluoropropane, and 4,4′-bis[4-(4-amino-2-trifluoromethyl)phenoxy]-octafluorobiphenyl; aromatic diamines, such as diaminotetraphenylthiophene, having two amino groups bonded to an aromatic ring and a hetero atom other than the nitrogen atoms in the amino groups; and aliphatic diamines and alicyclic diamines such as 1,1-m-xylylenediamine, 1,3-propanediamdine, tetramethylenediamine, pentamethylenediamine, octamethylenediamine, nonamethyleneddamine, 4,4-diaminoheptamethylenediamine, 1,4-diaminocyclohexane, isophoronediamine, tetrahydrodicyclopentadienyienediamine, hexahydro-4,7-methanoindanylenedimethylenediamine, tricycio[6,2,1,0^{2.7}]-undecylenedimethyldiamine, and 4,4′-methylenebis(cyclohexylamine).

Of these, the diamine compound may be an aromatic diamine compound. Specifically, the diamine compound is preferably p-phenylenediamine, m-phenylenediamine, 4,4′-diaminodiphenylmethane, 4,4′-diaminodiphenyl ether, 3,4′-diaminodiphenyl ether, 4,4′-diaminodiphenyl sulfide, or 4,4′-diaminodiphenylsulfone and particularly preferably 4,4′-diaminodiphenyl ether or p-phenylenediamine.

One diamine compound may be used alone, or two or more diamine compounds may be used in combination. When two or more diamine compounds are used in combination, a combination of aromatic diamine compounds or a combination of aliphatic diamine compounds may be used, or a combination of an aromatic diamine compound and an aliphatic diamine compound may be used.

The polyimide precursor may be any of various polymers including a polymer of an aromatic tetracarboxylic dianhydride and an aromatic diamine compound, a polymer of an aromatic tetracarboxylic dianhydride and an aliphatic diamine compound, a polymer of an aliphatic tetracarboxylic dianhydride and an aromatic diamine compound, and a polymer of an aliphatic tetracarboxylic dianhydride and an aliphatic diamine compound. From the viewpoint of obtaining a porous polyimide film having high mechanical strength, the polyimide precursor may be a polymer of an aromatic tetracarboxylic dianhydride and an aromatic diamine compound.

The weight average molecular weight of the polyimide precursor used in the present exemplary embodiment is preferably from 5000 to 300000 inclusive and more preferably from 10000 to 150000 inclusive.

The weight average molecular weight of the polyimide precursor is measured by gel permeation chromatorgraphy (GPC) under the following measurement conditions.
Column: TOSOH TSKgel α-M (7.8 mm I.D.×30 cm)
Eluent: DMF (dimethylformamide)/30 mM LiBr/60 mM phosphoric acid
Flow rate: 0.6 mL/min
Injection amount: 60 μL
Detector: RI (differential refractive index detector)

The content of the polyimide precursor contained in the olyimide precursor solution according to the present. exemplary embodiment may be from 0.1% by mass to 40% by mass inclusive and preferably from 1% by mass to 25% by mass inclusive based on the total Mass of the polyimide precursor solution.

### <Particles>

The polyimide precursor solution according to the present exemplary embodiment contains particles.

No particular limitation is imposed on the material of the particles so long as the particles do not dissolve in the polyimide precursor solution, but are dispersed therein, and can be removed in a particle removing step, described later when a porous polymide film is produced. The particles are broadly classified into resin particles and inorganic particles described later.

In the present specification, the phrase “the particles do not dissolve” is intended to encompass not only the case where the particles do not dissolve in a target liquid at 25° C. but also the case where the particles can dissolve in the target liquid in an amount of 3% by mass or less at 25° C.

No particular limitation is imposed on the volume average particle diameter D50v of the particles. The volume average particle diameter D50v of the particles may be, for example, in the range of from 0.1 μm to 30 μm inclusive and is preferably from 0.15 μm to 10 μm inclusive, more preferably from 0.2 μm to 5 μm inclusive, and still more preferably from 0.25 μm to 1 μm inclusive. When the volume average particle diameter of the particles in the above range, aggregation of the particles tends to be inhibited, and segregation of the bores in the porous polyimide film to be obtained is prevented, so that a porous polyimide film having both a low dielectric constant and high mechanical strength may be easily obtained. When the particles are resin particles, resin particle productivity may be easily improved.

The volume-based particle size distribution index (GSDv) of the particles is preferably 1.30 or less, more preferably 1.25 or less, and most preferably 1.20 or less. The volume-based particle size distribution index of the particles is computed from the particle size distribution of the particles in the polyimide precursor solution as (D841v/D16v)^{1/2}.

The particle size distribution of the particles in the polyimide precursor solution according to the present exemplary embodiment is measured as follows. The solution used for the measurement is diluted, and a Coulter counter LS13 (manufactured by Beckman Coulter, Inc.) is used to measure the particle size distribution of the particles in the solution. The measured particle size distribution is divided into different particle size ranges (channels), and a volume-based cumulative distribution is drawn from the small diameter size.

In the volume--based cumulative distribution drawn from the small diameter side, the particle diameter at a cumulative frequency of 16% is defined as a volume-based particle diameter D16v, the particle diameter at a cumulative frequency of 50% is defined as a volume average particle diameter D50v, and the particle diameter at a cumulative frequency of 84% is defined as a volume-based particle diameter D84v.

If the volume-based particle size distribution of the particles in the polyimide precursor solution in the present exemplary embodiment is not easily measured by the above method, the particle size distribution may be measured using another method such as dynamic light scattering.

The particles may have a spherical shape. When spherical particles are used to produce a porous polyimide film, the porous polyimide film obtained has spherical pores,

In the present specification, the term “spherical” used for the particle is meant to encompass a. spherical shape and substantially spherical shapes (shapes close to spheres). Specifically, the term means that the ratio of particles in which the ratio of the major axis to the minor axis (the major axis/the minor axis) is from 1 to 1.5 inclusive is 90% or more. The closer the redo of the major axis to the minor axis is to 1, the closer the shape is to a perfect sphere.

The particles used may be resin particles or may be inorganic particles, but resin particles may be used.

When the particles used are resin particles, the particles are removed during heating for firing a film of the polyimide precursor solution in the course of forming a porous polyimide film. Therefore, when the particles used are resin particles, it in unnecessary to perform an additional operation for removing the particles that is necessary when the particles used are inorganic particles, so that the porous polyimide film may be easily obtained at low cost.

The resin particles and also the polyimide precursor are organic materials. Therefore, when the resin particles are used, the dispersibility of the particles in the polyimide precursor solution or a coating of the polyimide precursor solution, the interfacial adhesion between the particles and the polyimide precursor, etc. may be higher than when inorganic particles are used. Moreover, the resin particles absorb volume shrinkage well in an imidization step in the course of producing a polyimide film, so that cracking of the polyimide film due to the volume shrinkage may be less likely to occur.

Specific materials of the resin particles and the inorganic particles will be described.

### —Resin Particles—

Specific examples of the resin particles include resin particles formed of: vinyl-based polymers typified by polystyrenes, poly(meth)acrylic acids, polyvinyl acetates, polyvinyl alcohols, polyvinyl butyrals, polyvinyl ethers, etc.; condensed polymers typified by polyesters, polyurethanes, polyamides, etc.; hydrocarbon-based polymers typified by polyethylenes, polypropylenes, polybutadienes, etc.; and fluorine-based polymers typified by polytetrafluoroethylene, polyvinyl fluorides, etc.

The term “(meth)acrylic” is meant to encompass “acrylir'” and “methabrylic.” The (meth)abrylic acids include (meth)acrylic acid, (meth)abrylates, and (meth)acrylamide.

The resin particles may be crosslinked or may not be crosslinked. When the resin particles are crosslinked, a bifunctional monomer such as divinylbenzene, ethylene glycol dimethacrylate, nonane diacrylate, or decanediol diacrylate or a polyfunctional monomer such as trimethylolpropane triacrylate or trimethyloipropane trimethacrylate may be used in combination with any of the above materials.

When the resin particles are vinyl resin particles, the resin particles are obtained by polymerizing a monomer. Examples of the monomer of the vinyl resin include the following monomers. Specifically, examples of the vinyl resin include vinyl resin units obtained by polymerizing monomers such as: styrenes having a styrene skeleton such as styrene, alkyl-substituted styrenes (such as α-methylstyrene, 2-methylstyrene, 3-methylstyrene, 4-methylstyrene, 2-ethylstyrene, 3-ethylstyrene, and 4-ethylstyrene), halogen-substituted styrenes (such as 2-chlorostyrene, 3-chlorostyrene, and 4-chlorostyrene), and vinyinaphthalene; (meth)acrylates such as methyl(meth)acrylate, ethyl(meth)acrylate, n-propyl(meth)acrylate, n-butyl(meth)acrylate, lauryl(meth)acrylate, and 2-ethylhexyl(meth)acrylate; vinyl nitriles such as acrylonitrile and methacrylonitrile; vinyl ethers such as vinyl methyl ether and vinyl isobutyl ether; vinyl ketones such as vinyl methyl ketone, vinyl ethyl ketone, and vinyl isopropenyl ketone; acids such as (meth)acrylic acid, maleic acid, cinnamic acid, fumaric acid, and vinylsulfonic acid; and bases such as ethylenimine, vinylpyridine, and vinylamine.

Another monomer, for example, a monofunctional monomer such as vinyl acetate, may be used in combination of any of the above monomers.

The vinyl resin may be a resin formed using one of these monomers or may be a copolymer resin formed using two or more of these monomers.

From the viewpoint of manufacturability and adaptability to a particle removal step described later, the resin particles are preferably particles of resins such as polystyrenes and poly(meth)acrylic acids. Specifically, the resin particles are more preferably particles of resins such as polystyrenes, styrene-(meth)acrylic acid copolymers, and poly(meth)acrylic acids and most preferably particles of resins such as polystyrenes and poly(meth)acrylic acids. One type of resin particles may be used alone, or two or more types may be used in combination.

The resin particles may retain their shape in the process for producing the polyimide precursor solution according to the present exemplary embodiment and before the removal of the resin particles in the process for applying the polyimide precursor solution and drying the coating when a porous polyimide film is produced. From this point of view, the glass transition temperature of the resin particles may be 60° C. or higher and is preferably 70° C. or higher and more preferably 80° C. or higher.

The glass transition temperature is determined using a DSC curve obtained by differential scanning calorimetry (DSC). More specifically, the glass transition temperature is determined from “extrapolated glass transition onset temperature” described in a glass transition temperature determination method in “Testing methods for transition temperatures of plastics” in JIS K7121-1987.

### —Inorganic Particles—

Specific examples of the inorganic particles include silica (silicon dioxide) particles, magnesium oxide particles, alumina particles, zirconia particles, calcium carbonate particles, calcium oxide particles, titanium dioxide particles, zinc oxide particles, and cerium oxide particles. The particles may have a spherical shape as described above. From this point of view, the inorganic particles are preferably silica particles, magnesium oxide particles, calcium carbonate particles, magnesium oxide particles, or alumina particles, more preferably silica particles, titanium oxide particles, or alumina particles, and still more preferably silica particles. One type of these inorganic particles may be used alone, or two or more types may be used in combination.

When the wettability of the inorganic particles by the solvent of the polyimide precursor solution and the dispersibility of the inorganic particles in the solvent are insufficient, the surface of the inorganic particles may be optionally modified. Examples of the surface modification method include: a method including treating the surface with alkoxy silane having an organic group that is typified by a silane coupling agent; and a method including coating the surface with an organic acid such as oxalic acid, citric acid, or lactic acid.

In the present exemplary embodiment, the volume content of the particles based on the total volume of the polyimide precursor and the particles is preferably from 50% by volume to 70% by volume inclusive, more preferably from 52% by volume to 68% by volume inclusive, and still more preferably from 55% by volume to 65% by volume inclusive.

Since the polyimide precursor solution according to the present exemplary embodiment contains the specific compound, a porous polyimide film having both a low dielectric constant and high mechanical strength can be obtained even when the content of the particles is in the above range.

When the content of the particles is in the above range, the dielectric constant of a porous polyimide film to be obtained is lower than when the content is below the above range, and the mechanical strength of the porous polyimide film to be obtained is higher than when the content is beyond the above range.

One method for determining the volume of the particles contained in a specific amount of the polyimide precursor solution includes: filtering the polyimide precursor solution; and then determining the difference between the volume of the polyimide precursor solution before the filtration and the volume of the filtrate after the filtration.

One method for determining the volume of the polyimide precursor contained in a specific amount of the polyimide precursor solution include: applying the polyimide precursor solution to a substrate; measuring the volume of a dried film dried at 200° C. for 1 hour using a laser volumeter; and determining the volume of the polyimide precursor from the difference between the volume of the dried film and the volume of the particles determined by the above-described method.

The content of the particles is preferably from 0.1% by mass to 20% by mass inclusive, more preferably from 0.5% by mass to 20% by mass inclusive, and still more preferably from 1% by mass to 20% by mass inclusive based on the total mass of the polyimide precursor solution.

### <Solvent>

The polyimide precursor solution in the present exemplary embodiment contains the solvent.

No particular limitation is imposed on the solvent so long as the polyimide precursor dissolves in the polyimide precursor solution and the particles do not dissolve in the polyimide precursor solution but are dispersed therein.

The solvent may contain water. The solubility of the specific compound in the solvent containing water is higher than the solubility of the specific compound in a solvent containing no water. By increasing the concentration of the specific compound, a porous polyimide film having a low dielectric constant and high mechanical strength can be easily obtained.

Examples of the water include distilled water, ion exchanged water, ultrafiltrated water, and pure water.

From the viewpoint of increasing the concentration of the specific compound, the content of the water based on the total mass of the solvent is preferably from 50% by mass to 100% by mass inclusive and more preferably from 70% by mass to 100% by mass inclusive.

Hereinafter, a solvent in which the content of water based on the total mass of the solvent is 50% by mass or more is referred to as a “water-based solvent,” and a solvent in which. the content of water based on the total mass of the solvent is less than 50% by mass and which contains an organic solvent is referred to as an “organic-based solvent.”

### —Water-Based Solvent—

The water—based solvent may contain a solvent other than water. Examples of the solvent other than water include water-soluble organic solvents and aprotic polar solvents. From the viewpoint, of mechanical strength etc. of the porous polyimide film to be obtained, the solvent other than water may be a water-soluble organic solvent. The term “water-soluble material” means that the material can dissolve in water at 25° C. in an amount of 1% by mass or more.

When the particles used are the resin particles and the solvent used is a water-based. solvent containing a water-soluble organic solvent, the content of the water-soluble organic solvent based on the total mass of the water-based solvent is 40% by mass or less and preferably 30% by mass or less in order to prevent dissolution and swelling of the particles in the polyimide precursor solution. To prevent dissolution and swelling of the particles when a coating of the polyimide precursor solution is dried to form a coating film, the content of the water-soluble organic solvent is from 3% by mass to 50% by mass inclusive, preferably from 5% by mass to 40% by mass inclusive, and more preferably from 5% by mass to 35% by mass inclusive based on the total amount of the particles and the polyimide precursor in the polyimide precursor solution.

Examples of the water-soluble organic solvent include a water-soluble ether-based solvent described below, a water-based ketone-based solvent described below, and a water-soluble alcohol-based solvent described below.

The water-soluble ether-based solvent is a water-soluble organic solvent having an ether bond in its molecule. Examples of the water-soluble ether-based solvent include tetrahydrofuran (THF), dioxane, trioxane, 1,2-dimethoxyethane, diethylene glycol dimethyl ether, and diethylene glycol diethyl ether. In particular, the water-soluble ether-based solvent may be tetrahydrofuran or dioxane.

The water-based ketone-based solvent is a water-soluble organic solvent having a ketone group in its molecule. Examples of the water-based ketone-based solvent include acetone, methyl ethyl ketone, and cyclohexanone. In particular, the water-based ketone-based solvent may be acetone.

The water-soluble alcohol-based solvent is a water-soluble organic solvent having an alcoholic hydroxy group in its molecule. Examples of the water-soluble alcohol-based solvent include methanol, ethanol, 1-propanol, 2-propanol, tert-butyl alcohol, ethylene glycol, monoalkyl ethers of ethylene glycol, propylene glycol, monoalkyl ethers of propylene glycol, diethylene glycol monoalkyl ethers of diethylene glycol, 1,2-propanediol, 1,3-propanediol, 1,3-butanediol, 1, 4-butanediol, 2,3-butanediol, 1,5-pentanediol, 2-butene-1,4-diol, 2-methyl-2,4-pentanediol, glycerin, 2-ethyl-2-hydroxymethyl-1,3-propanediol, and 1,2,6-hexanetriol. In particular, the water-soluble alcohol-based. solvent may be methanol, ethanol, 2-propanol, ethylene glycol, a monoalkyl ether of ethylene glycol, propylene glycol, a monoalkyl ether of propylene glycol, diethylene glycol, or a monoalkyl ether of diethylene glyool.

From the viewpoint of improving various properties of the porous polyimide film to be obtained e.g., transparency, mechanical strength, heat resistance, electric properties, solvent resistance, etc.), the water-based solvent may contain an aprotic polar solvent. In this case, to prevent dissolution and swelling of the particles in the polyimide precursor solution, the content of the aprotic polar solvent is 40% by mass or less and preferably 30% by mass or less based on the total mass of the water-based solvent. To prevent dissolution and swelling of the particles when the polyimide precursor solution is dried to form a coating film, the content of the aprotic polar solvent is from 3% by mass to 200% by mass preferably from 3% by mass to 100% by mass inclusive, more preferably from 3% by mass to 50% by mass inclusive, and still more preferably from 5% by mass to 50% by mass inclusive, based on the total mass (solid contents) of the particles and the polyimide precursor in the polyimide precursor solution.

One of the above aprotic polar solvents may be used alone, or two or more of them may be used in combination.

When the water-based solvent contains an aprotic polar solvent other than water, the aprotic polar solvent used in combination with water may be an organic solvent having a boiling point of from 150° C. to 300° C. inclusive and a dipole moment of from 3.0 D to 5.0 D inclusive. Specific example-, of the aprotic polar solvent. include N-methyl-2-pyrrolidone (NMP), N,N-dimethylformamide (DMF), N,N-dimethylacetamide (DMAc), dimethyl sulfoxide (DMSO), hexamethylenephosphdramide (HMPA), N-methylcaprolactam, N-acetyl-2-pyrrolidone, 1,3-dimethyl-2-imidazoliddnone (DMI), N,N′-dimethylpropyleneurea, tetramethylurea, trimethyl phosphate, and triethyl phosphate.

When the water-based solvent contains a solvent other than water, the boiling point of the solvent used in combination with water may be 270° C. or lower, preferably from 60° C. to 2s0° C. inclusive, and. more preferably from 80° C. to 230° C. inclusive. When the boiling point of the solvent used is in the above range, the solvent other than water is unlikely to remain in the polyimide film. This easily allows the polyimide film to be obtained to have high mechanical strength.

### —Organic-Based Solvent—

The organic-based solvent is selected such that the polyimide precursor dissolves in the polyimide precursor solution but the particles do not dissolve therein and are dispersed. therein. The organic-based solvent may be a solvent mixture of a good solvent (S1) for the polyimide precursor and a solvent (S2) other than the good solvent (S1).

The good solvent (S1) for the polyimide precursor is a solvent in which the solubility of the polyimide precursor is 5% by mass or more. Specific examples of the good solvent (S1) include aprotic polar solvents such as N,N-dimethylformamide, N,N-dimethylacetamide, N-methylpyrrolidone, N-ethylpyrrolidene, tetramethylurea, 1,3-dimethyl-2-imidazolidinone, dimethylpropyleneurea, dimethyl sulfoxide, γ-butyrolactone, β-propiolactone, γ-valerolactone, δ-valerolactone, and γ-caprolactone.

Of these, N,N-dimethylacetamide, N-methylpyrrolidone, tetramethylurea, 1,3-dimethyl-2-imidazolidinone, dimethyl sulfoxide, and γ-butyrolactone are preferred, and N,N-dimethylacetamide, N-methylpyrrolidene, tetramethylurea, dimethyl sulfoxide, and γ-butyrolactone are more preferred. N,N-dimethylacetamide, N-methylpyrrolidone, and γ-butyrolactone are still more preferred.

The solvent (S2) other than the good solvent for the polyimide precursor is selected such that the solubility of the particles used in the solvent (S2) is low. In one example of a method for selecting the solvent, the particles are added to candidate solvents, and a solvent that dissolves 3% by mass or less of the particles is selected.

Examples of the solvent (S2) other than the good solvent for the polyimide precursor include: hydrocarbon-based solvents such as n-decane and toluene; alcohol-based solvents such as isopropyl alcohol, 1-propanol, 1-butanol, 1-pentanol, and phenethyl alcohol; glycol-bases solvents such as ethylene glycol, propylene glycol, ethylene glycol monomethyl ether, 1-methoxy-2-propanol, diethylene glycol monomethyl ether, and triethylene glycol monomethyl ether; ether-based solvents such as diglyme, triglyme, tetraglyme, and methyl cellosolve acetate; and phenol-based solvents such as phenol and cresol.

The polarity of the solvent (S1) is generally high. When the particles used are the above-described resin particles and the solvent (S1) is used alone, the solvent (S1) may dissolve not only the polyimide precursor but also the resin particles. Therefore, the mixing ratio of the solvent (S1) to the solvent (S2) may be determined such that the polyimide precursor dissolves in the mixture and the resin particles do not dissolve therein. To prevent, for example, the shape deformation of the pores caused by dissolution of the resin particles during heating of the coating of the polyimide precursor solution, the boiling point of the solvent (S2) is higher than the boiling point of the solvent (S1) by preferably at least 10° C. and more preferably at least 20° C.

### <Specific Compound>

The polyimide precursor solution in the present exemplary embodiment contains the specific compound.

No particular limitation is imposed on the specific compound so long as it is a compound having at least four non-dehydrated carboxy groups per molecule.

The number of carboxy groups included in one molecule of the specific compound may be, for example, in the range of from. 4 to 6 inclusive and is preferably in the range of from 4 to 5 inclusive and more preferably 4.

The specific compound may be a compound having an aromatic ring or may be a compound having no aromatic ring. From the viewpoint of obtaining a porous polyimide film having high mechanical strength, the specific compound is preferably a compound having an aromatic ring and more preferably an aromatic tetracarboxylic acid.

An aromatic compound used as the specific compound may have a benzene ring as the aromatic ring, may have an aromatic heterocycle, or may have both a benzene ring and an aromatic heterocycle.

The aromatic heterocyole is an aromatic ring having an element other than carbon in its ring, and examples of the aromatic heterocycle include a thiophene ring, a thiophyne ring, a pyrrole ring, a furan ring, heterocycles obtained by replacing carbon atoms at positions 3 and 4 in any of the above rings with nitrogen, and a pyridine ring.

The aromatic compound used as the specific compound may be a compound having one aromatic ring per molecule or may be a compound having two or more aromatic rings per molecule. The number of aromatic rings in the aromatic compound used as the specific compound is preferably from 1 to 8 inclusive, more preferably from 1 to 5 inclusive, and. still more preferably from 1 to 3 inclusive. The specific compound is preferably a tetracarboxylic acid having 1 to 8 aromatic rings, more preferably tetracarboxylic acid having 1 to 5 aromatic rings, and still more preferably a tetracarboxylic acid having 1 to 3 aromatic rings.

Examples of the aromatic compound having two or more aromatic rings include: a compound having polynuclear aromatic rings in which atoms in different rings are bonded together; and a compound having condensed aromatic rings in which two or more atoms in one ring are shared with another ring. In polynuclear aromatic rings, atoms in different rings may be bonded directly by a covalent bond or may be bonded through a linking group.

Examples of the compound having polynuclear aromatic rings include compounds having a biphenyl skeleton, a terphenyl skeleton, a terphenyl skeleton, a stilbene skeleton, a triphenylethylene skeleton, etc. Examples of the compound having condensed aromatic rings include compounds having a naphthalene skeleton, an anthracene skeleton, a phenanthrene skeleton, a pyrene skeleton, a perylene skeleton, a fluorene skeleton, etc.

The aromatic compound having two or more aromatic rings may be a compound having both polynuclear aromatic rings and condensed aromatic rings.

Specific examples of the aromatic compound used as the specific compound include aromatic tetracarboxylic acids such as pyromellitic acid, 3,3′,4,4′-benzophenonetetracarboxylic acid, 3,3′,4,4′-biphenylsulfonetetracarboxylic acid, 1,4,5,8-naphthalenetetracarboxylic acid, 2,3,6,7-naphthalenetetracarboxylic acid, 3,3′,4,4′-biphenylethertetracarboxylic acid, 3,3′,4,4′-dimethyldiphenylsilanetetracarboxylic acid, 3,3′,4,4′-tetraphenylsilanetetracarboxylic acid, 1,2,3,4-furantetracarboxylic acid, 4,4′-bis(3,4-dicarboxyphenoxy)diphenylsuifide, dicarboxyphenoxy)diphenylsulfone, 4,4′-bis(3,4-dicarboxyphenoxy)diphenylpropane, 3,3′,4,4′-perfluoroisopropylidenediphthalic acid, 3,3′,4,4′-biphenyltetracarboxylic acid, 2,3,3′,4′-biphenyltetracarboxylic acid, bis(phthalic acid)phenylphosphine oxide, p-phenylene-bis(triphenylphthalic acid), m-phenylene-bis(triphenylphthalic acid), bis(triphenylphthalic acid)-4,4′-diphenyl ether, bis(triphenylphthalic acid)-4,4′-diphenylmethane, 1,3,3a,4,5,9b-hexahydro-2,5-dioxo furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione.

Specific examples of an aliphatic compound used as the specific compound include aliphatic tetracarboxylic acids such as butanetetracarboxylic acid, 1,2,3,4-cyclobutanetetracarboxylic acid, 1,3-dimethyl-1,2,3,4-cyclobutanetetracarboxylic acid, 1,2,3,4-cyclopentanetetracarboxylic acid, 2,3,5-tricarboxycyclopentylacetic acid, 3,5,6-tricarboxynorbornane-2-acetic acid, 2,3,4,5-tetrahydrofurantetracarboxylic acid, 5-(2,5-dioxotetrahydrofuryl)-3-methyl-3-cyclohexene-1,2-dicarboxylic acid, and bicyclo[2,2,2]-oct-7-ene-2,3,5,6-tetracarboxylic acid.

In particular, the specific compound is preferably an aromatic tetracarboxylic acid, more preferably a tetracarboxylic acid having at least one of a benzene ring and a naphthalene still more preferably at least one selected from the group consisting of pyromellitic acid, 3,3′,4,4′-benzophenonetetracarboxylic acid, 3,3′,4,4′-biphenylsulfonetetracarboxylic acid, 1,4,5,8-naphthalenetetracarboxylic acid, and 2,3,6,7-naphthalenetetracarboxylic acid, and particularly preferably at least one selected from the group consisting of pyromellitic acid, 3,3′,4,4′-benzophenonetetracarboxylic acid, 1,4,5,8-naphthalenetetracarboxylic acid, and 2,3,6,7-naphthalenetetracarboxylic acid.

No particular limitation is imposed on the molecular weight of the specific compound. The molecular weight of the specific compound may be in the range of from 150 to 500 inclusive and is preferably in the range of from 180 to 480 inclusive and more preferably in the range of from 200 to 450 inclusive.

The content of the specific compound based on 100 parts by mole of units derived from the tetracarboxylic dianhydride contained in the polyimide precursor is preferably from 0.3 parts by mole to 2.0 parts by mole inclusive, more preferably from 0.4 parts by mole to 1.7 parts by mole inclusive, and still more preferably from 0.5 parts by mole to 1.5 parts by mole inclusive.

When the content of the specific compound is in the above range, the effect of the specific compound as a crosslinking agent may be higher than when the content is below the above range, and a porous polyimide film having both a low dielectric constant and high mechanical strength may be easily obtained. When the content. of the specific compound is in the above range, the unreacted specific compound may be less likely to remain in a fired film of the polyimide precursor solution than when the content of the specific compound is beyond the above range, and a reduction in the strength of the porous polyimide film due to the remaining unreacted specific compound may be less likely to occur.

### <Organic Amine Compound>

When the solvent contains water, the polyimide precursor solution may optionally contain an organic amine compound in order to dissolve the polyimide precursor in the solvent. In particular, when the solvent is the water-based solvent, the polyimide precursor solution may contain an organic amine compound. When the polyimide precursor solution contains the organic amine compound, the polyimide precursor becomes water-soluble. The organic amine compound is a compound that forms an amine salt with a carboxy group in the polyimide precursor to increase its solubility in the solvent containing water and also functions as an imidization promoter. Therefore, when. the solvent used. contains water and the polyimide precursor solution contains the organic amine compound, a porous polyimide film having high mechanical strength may be easily obtained.

Specifically, the organic amine compound may be an amine compound having a molecular weight of 170 or less. The organic amine compound may be a compound other than the diamine compound used as a raw material of the polyimide precursor.

The organic amine compound may be a water-soluble compound. The term “water-soluble material” means that the material can dissolve in water at 25° C. in an amount of 1% by mass or more.

Examples of the organic amine compound include primary amine compounds, secondary amine compounds, and tertiary amine compounds.

In particular, the organic amine compound is preferably at least one selected from the group consisting of secondary amine compounds and tertiary amine compounds and is more preferably tertiary amine compound. When the organic amine compound used is at least one selected from the group consisting of secondary amine compounds and tertiary amine compounds, the solubility of the polyimide precursor in the solvent may increase, and film formability may be improved. Moreover, the storage stability of the polyimide precursor solution may increase.

Examples of the organic amine compound include, in addition to the monovalent amine compounds, divalent and higher polyvalent amine compounds. When a divalent or higher polyvalent amine compound is used, a pseudo-crosslinked structure may be easily formed between molecules of the polyimide precursor, and the storage stability of the polyimide precursor solution may be improved,

Examples of the primary amine compound include methylamine, ethylamine, n-propylamine, isopropylamine, 2-ethanolamine, and 2-amino-2-methyl-1-propanol.

Examples of the secondary amine compound include dimethylamine, 2-(methylamino)ethanol, 2-(ethylamino)ethanol, and morpholine.

Examples of the tertiary amine compound include 2-dimethylaminoethanol, 2-diethylaminoethanol, 2-dimethylaminopropanol, pyridine, triethylamine, picoline, N-methylmorpholine, N-ethylmorpholine, 1,2-dimethylimidazole, and 2-ethyl-4-methylimidazole,

From the viewpoint of the pot life of the polyimide precursor solution and the uniformity in film thickness, a tertiary amine compound is preferable. From this point of view, the organic amine compound is more preferably at least one selected from the group consisting of 2-dimethylaminoethanol, 2-diethylaminoethanol, 2-dimethylaminopropanol, pyridine, triethylamine, picoline, N-methylmorpholine, N-ethylmorpholine, 1,2-dimethylimidazole, 2-ethyl-4-methylimidazole, N-methylpiperidine, and N-ethylpiperidine. The organic amine compound is most preferably at least one selected from the group consisting of 2-dimethylaminoethanol, 2-diethylaminoethanol, 2-dimethylaminopropanol, triethylamine, N-methyimorpholine, N-ethylmorpholine, 1,2-dimethylimidazole, 2-ethyl-4- methylimidazorle, N-methylpiperidine, and N-ethylpiperidine.

From the viewpoint of film formability, the organic amine compound may also be an amine compound (particularly a tertiary amine compound) having a nitrogen-containing heterocyclic structure. Examples of the amine compound having a nitrogen-containing heterocyclic structure thereinafter referred to as a “nitrogen-containing heterocyclic amine compound”) include isoquinolines (amine compounds having an isoquinoline skeleton), pyridines (amine compounds having a pyridine skeleton), pyrimidines (amine compounds having a pyrimidine skeleton), pyrazines (amine compounds having a pyrazine skeleton), piperazines (amine compounds having a piperazine skeleton), triazines (amine compounds having a triazine skeleton), imidazoles (amine compounds having an imidazole skeleton), morpholines (amine compounds having a morpholine skeleton), polyanilines, polypyridines, and polyamines.

From the viewpoint of film formability, the nitrogen-containing heterocyclic amine compound is preferably at least one selected from the group consisting of morpholines, pyridines, piperidines, and imidazoles and more preferably a morpholine (an amine compound having a morpholine skeleton). Of these, at least one selected from the group consisting of N-methylmorpholine, N-methylpiperidine, pyridine, 1,2-dimethylimidazole, 2-ethyl-4-methylimidazole, and picoline is more preferred, and N-methylmorpholine is still more preferred.

In particular, the organic amine compound may be a compound having a boiling point of 60° C. or higher (preferably from 60° C. to 200° C. inclusive and more preferably from 70° C. to 150° C. inclusive). When the boiling point of the organic amine compound is 60° C. or higher, volatilization of the organic amine compound from the polyimide precursor solution during storage may be prevented, and deterioration in the solubility of the polyimide precursor in the solvent may be prevented.

The content of the organic amine compound may be from. 50% by mole to 500% by mole inclusive and. is preferably from 80% by mole to 250% by mole inclusive and more preferably from 90% by mole no 200% by mole inclusive based on the amount of carboxy groups (—COOH) in the polyimide precursor in the polyimide precursor solution.

When the content of the organic amine compound is in the above range, the solubility of the polyimide precursor in the solvent may increase, and film formability may be improved. Moreover, the storage stability of the polyimide precursor solution may be improved.

One of the above organic amine compounds may be used alone, or two or more of them may be used in combination.

### <Additional Additives>

The polyimide precursor solution according to the present exemplary embodiment may contain a catalyst for promoting the imidization reaction and a leveling agent for improving the quality of a film product.

The catalyst for promoting the imidization reaction may be a dehydrator such as an acid anhydride or an acid catalyst such as a phenol derivative, a sulfonic acid derivative, or a benzoic acid derivative,

For example, the polyimide precursor solution may further contain an electrically conductive material for imparting electrical conductivity. The electrically conductive material may be a material exhibiting electrical conductivity (e.g., a volume resistivity of less than 10⁷ Ω·cm) or may be a semiconductive material (e.g., a volume resistivity of from 10⁷ Ω·cm to 10¹³ Ω·cm inclusive).

Examples of the electrically conductive material include: carbon black (such as acidic carbon black having a pH of 5.0 or less); metals (such as aluminum and nickel); metal oxides (such as yttrium oxide and tin oxide); and ion conductive materials (such as potassium titanate and LiCl). One of these electrically conductive materials may be used alone, or two or more of them may be used in combination.

The polyimide precursor solution according to the present exemplary embodiment may contain LiCoO₂, LiMn₂O, etc. used for electrodes of lithium ion batteries.

### <Method for Producing Polyimide Precursor Solution>

Examples of a method for producing the polyimide precursor solution according to the present exemplary embodiment include the following method (i) and the following method (ii).

(i) A method including producing a solution containing the polyimide precursor and then adding the particles and the specific compound thereto.

(ii) A method including producing a particle dispersion, synthesizing the polyimide precursor in the dispersion, and then adding the specific compound.

In particular, from the viewpoint of improving the dispersibility of the particles, the method (ii) may be used as the method for producing the polyimide precursor solution according to the present exemplary embodiment,

(i) Method Including Producing solution of polyimide Precursor and then Adding Particles and Specific Compound

First, the solution of the Polyimide Precursor without the particles dispersed therein is obtained using any known method. Specifically, for example, the tetracarboxylic dianhydride and the diamine compound are polymerized in a solvent. to produce the polyimide precursor, and the solution of the polyimide precursor is thereby obtained.

When the solvent used is a water-based solvent, the polymerization may be performed in the presence of an organic amine to obtain the solution of the polyimide precursor. In another example, the tetracarboxylic dianhydride and the diamine compound are polymerized in an organic solvent such as an aprotic polar solvent (e.g., N-methylpyrrolidone (NMP)) to produce the polyimide precursor, and the resulting mixture is added to the water-based solvent to precipitate the polyimide precursor. Then the polyimide precursor and the organic amine compound are dissolved in the water-based solvent to thereby obtain the solution of the polyimide precursor.

Next, the particles and the specific compound are added to the obtained solution of the polyimide precursor. No particular limitation is imposed on the order of addition of the particles and the specific compound to the solution of the polyimide precursor. The specific compound may be added to the solution of the polyimide precursor after the addition of the particles, or the particle may be added to the solution of the polyimide precursor after the addition of the specific compound. The particles and the specific compound may be added simultaneously.

When the particles are, for example, vinyl resin particles, the particles may be produced in a water-based solvent by a well-known polymerization method (radical polymerization such as emulsion polymerization, soap-free emulsion polymerization, suspension polymerization, miniemulsion polymerization, or microemulsion polymerization).

For example, when emulsion polymerization is applied to the production of the vinyl resin particles, a monomer such as styrene or (meth)acrylic acid is added to a water-based solvent containing dissolved therein a water-soluble polymerization initiator such as potassium persulfate or ammonium persulfate. Then a surfactant such as sodium dodecyl sulfate or diphenyl oxide disulfonate is optionally added, and the mixture is heated under stirring to perform polymerization, and the vinyl resin particles are thereby obtained.

When the vinyl resin particles are added to the solution of the polyimide precursor containing a water-based solvent, for example, the water-based solvent dispersion of the resin particles obtained by the above-described method and the above-obtained solution of the polyimide precursor are mixed and stirred, and the particles are thereby added.

When the vinyl resin particles are added to the solution of the polyimide precursor containing an organic-based solvent, the resin particles are collected as powder from the water-based solvent dispersion of the resin particles using a well-known method such as reprecipitation or freeze-drying, and the collected resin particles and the above-obtained solution of the polyimide precursor are mixed and stirred. Alternatively, the collected resin particle powder may be re-dispersed in an organic-based solvent that does not dissolve the resin particles, and then the dispersion and the solution of the polyimide precursor may be mixed and stirred.

No particular limitation is imposed on the mixing method, the stirring method, and the dispersing method. To improve the dispersibility of the particles, a well-known nonionic or ionic surfactant may be added.

When commercial particles (resin particles or inorganic particles) in powder form are used, the particles are mixed and dispersed at a target concentration irrespective of whether the solvent for the polyimide precursor solution is an organic-based solvent or a water-based solvent. When the particles are obtained as a dispersion of the particles, the particle dispersion and the above-obtained solution of the polyimide precursor are mixed and dispersed using any of the methods described for the production of the particles to thereby add the particles.

When the specific compound is added, the specific compound may be added directly to the solution of the polyimide precursor that contains the particles added thereto, or a solution prepared by dissolving the specific compound in a solvent may be added. The specific compound may be added directly to the solution of the polyimide precursor that contains no particles added thereto solution prepared by dissolving the specific compound in a solvent may be added to the solution of the polyimide precursor chat contains no particles added thereto, or a specific compound-containing particle dispersion prepared by dissolving the specific compound in the particle dispersion may be added to the above solution.

(ii) Method Including Producing Particle Dispersion, Synthesizing Polyimide Precursor in Dispersion, and then Adding Specific Compound

When an organic-based solvent is used as the solvent for the polyimide precursor solution, first, a dispersion containing the particles dispersed in a solvent that does not dissolve the particles but dissolves the polyimide precursor is prepared. Next, the tetracarboxylic dianhydride and the diamine compound are polymerized in the dispersion to produce the polyimide precursor, and a solution of the polyimide precursor solution that contains the particles dispersed therein is thereby obtained. Then the specific compound is added directly to the obtained solution, or a solution prepared by dissolving the specific compound in a solvent is added to the obtained solution to thereby obtain the polyimide precursor solution according to the present exemplary embodiment.

When a water-based solvent is used as the solvent for the polyimide precursor solution, first, a water-based solvent dispersion of the particles is prepared. Next, the tetracarboxylic dianhydride and the diamine compound are polymerized in the dispersion in the presence of an organic amine to produce the polyimide precursor, and a solution of the polyimide precursor that contains the particles dispersed therein is thereby obtained. Then the specific compound is added directly to the obtained solution, or a solution prepared by dissolving the specific compound in a solvent is added to the obtained solution to thereby obtain the polyimide precursor solution according to the present exemplary embodiment.

When the particles used are resin particles, the surface of the resin particles may be coated with a resin having a chemical structure different from that of the original resin, in order to improve the dispersibility of the particles in the polyimide precursor solution according to the present exemplary embodiment. The coating resin may be changed according to the solvent used or the chemical structure of the polyimide precursor. Examples of the coating resin include resins having an acidic or basic group. The surface of the resin particles is coated with the resin, for example, using the following method. For example, when the vinyl resin particles are produced by emulsion polymerization, the monomer for the original resin particles is polymerized. After completion of the polymerization, a small amount of a monomer having an acidic or basic groups such as methacrylic acid or 2-dimethylaminoethyl methacrylate is added and polymerized.

### [Porous Polyimide Film]

A porous polyimide film according to an exemplary embodiment is a porous sintered product obtained from the above polyimide precursor solution and having pores. The porous polyimide film according to the present exemplary embodiment contains a reaction product of an imidization product of the polyimide precursor contained in the polyimide precursor solution and the specific compound contained in she polyimide precursor solution.

### <Method for Producing Porous Polyimide Film>

The porous polyimide film according to the present exemplary embodiment is obtained by the following production method.

The porous polyimide film production method according to the present exemplary embodiment includes: a first step of applying the polyimide precursor solution to a substrate to form a coating and drying the coating to thereby form a film containing the polyimide precursor, the specific compound, and the particles; and a second step of heating the film to imidize the polyimide precursor to thereby form a polyimide film, the second step including a process for removing the particles.

In the porous polyimide film production method according to the present exemplary embodiment, since the spherical particles are used, a porous polyimide film having spherical pores is obtained.

A preferred example of the porous polyimide film production method according to the present exemplary embodiment will be described with reference to the drawing.

The FIGURE is a schematic illustration showing the structure of the porous polyimide film obtained by the porous polyimide film production method according to the present exemplary embodiment.

In the FIGURE, 31 represents the substrate, 10A represents pores, and 10 represents the porous polyimide film.

### (First Step)

In the first step, first, the polyimide precursor solution described above is prepared. Next, the polyimide precursor solution is applied to the substrate to form a coating, and the coating is dried to form a film containing the polyimide precursor and the particles.

To form the coating, the polyimide precursor solution obtained by any of the above-described methods is applied to the substrate. The coating obtained contains at least the polyimide precursor, the particles, the specific compound, and the solvent.

The substrate to which the polyimide precursor solution is applied (the substrate 31 in the FIGURE) is selected according to the application of the porous polyimide film to be obtained. When the porous polyimide film is used alone, a polyimide film forming substrate may be used as the substrate. When the porous polyimide film is used as a coating film that coats the surface of a component, the component itself may be used as the substrate.

Examples of the polyimide film forming substrate include: resin substrates such as polystyrene substrates and polyethylene terephthalate substrates; glass substrates; ceramic substrates; metal substrates such as iron substrates and stainless steel (SUS) substrates; and composite material substrates formed of combinations of the above materials.

The polyimide film forming substrate may be optionally subjected to release treatment using, for example, a release agent such as a silicone-based or fluorine-based release agent to form a release layer. The surface of the polyimide film forming substrate may be roughened to about the size of the particles. This is effective because exposure of the particle at the contact surface of the substrate is facilitated.

When the porous polyimide film is used as a coating film that coats the surface of a component, specific examples of the component used as the substrate include: a wire body of an insulated wire described later; various substrates used for liquid crystal elements; semiconductor substrates on which integrated circuits are formed; wiring substrates on which wiring lines are formed; and substrates of printed circuit boards on which electric components and wiring lines are formed.

No particular limitation is imposed on the method for applying the polyimide precursor solution to the substrate. Examples of the method include various methods such as a spray coating method, a spin coating method, a roil coating method, a bar coating method, a slit-die coating method, and an inkjet coating method.

The application amount of the polyimide precursor solution may be set such that a prescribed film thickness is obtained.

The film is formed by drying the coating formed on the substrate. The film contains at least the polyimide precursor, the specific compound, and the particles.

No particular limitation is imposed on the method for drying the coating formed on the substrate, and examples of the method include various methods such as heat drying, air drying, and vacuum drying. More specifically, the coating may be dried to form the film such that the amount of the solvent remaining in the film is 50% by mass or less (preferably 30% by mass or less) based on the mass of solids in the film.

### (Second Step)

The second step is the step of heating the film obtained in the first step to imidize the polyimide precursor to thereby form the polyimide film and includes the process for removing the particles. The porous polyimide film is obtained through the process for removing the particles.

Specifically, in the second step, the film obtained in the first step is heated to allow the imidization to proceed, and the polyimide film is thereby formed. As the imidization proceeds and the imidization ratio increases, the polyimide film becomes more and more difficult to dissolve in the solvent.

Then, in the second step, the process for removing the particles is performed. When the particles are removed, the regions that were occupied by the particles become pores (pores 10A in the FIGURE), and the porous polyimide film (the porous polyimide film 10 in the FIGURE) is thereby obtained.

The particles may be removed in the course of heating the film to imidize the polyimide precursor or may be removed from the polyimide film after imidization.

From the viewpoint of ease of removing the particles, the process for removing the particles may be performed when the imidization ratio of the polyimide precursor in the polyimide film is 10% or more in the course of imidizing the polyimide precursor. When the imidization ratio is 10% or more, the shape of the film easily maintained.

### —Removal of Particles—

Next, the process for removing the particles will be described.

First, the process for removing the resin particles will be described.

Examples of the process for removing the resin particles include a method in which the resin particles are removed by heating, a method in which the resin particles are removed using an organic solvent that can dissolve the resin particles, and a method in which the resin particles are removed by decomposing using, for example, a laser. Of these, the method in which the resin particles are removed by heating and the method in which the resin particles are removed using an organic solvent that can dissolve the resin particles may be used.

In the removal method using heating, for example, the resin particles may be removed by decomposing the resin particles by heat used to promote the imidization in the course of imidizing the polyimide precursor. In this case, the number of steps is smaller because the operation for removing the resin particles using an organic solvent is unnecessary.

When the resin particles are removed by heat to form pores, it is necessary that the resin particles do not decompose at the drying temperature after application but thermally decompose at the temperature at which the film of the polyimide precursor is imidized. From this point of view, the thermal decomposition start temperature of the resin particles may be from 150° C. to 320° C. inclusive and is preferably from 180° C. to 300° C. inclusive and more preferably from 200° C. to 280° C. inclusive.

Examples of the method in which the resin particles are removed using an organic solvent that can dissolve the resin particles include a method in which the resin particles are brought into contact with the organic solvent that can dissolve the resin particles (e.g., immersed in the organic solvent) to dissolve and remove the resin particles. In the method in which the resin particles are immersed in the organic solvent, the efficiency of dissolution of the resin particles is high.

No particular limitation is imposed on the organic solvent for removing the resin particles so long as it does not dissolve the polyimide film and the polyimide film after completion of the imidization but can dissolve the resin particles. Examples of the organic solvent include: ethers such as tetrahydrofuran (THF); aromatics such as toluene; ketones such as acetone; and esters such as ethyl acetate.

Resin particles that dissolve in a general-purpose solvent such as tetrahydrofuran, acetone, toluene, or ethyl acetate may be used when de resin particles are removed by dissolution to form pores. Depending on the type of resin particles used and the type of polyimide precursor used, water may be used as the solvent for removing the resin particles.

Next, the process for removing the inorganic particles will be described.

Examples of the process for removing the inorganic particles include a method in which the inorganic particles are removed using a liquid that dissolves the inorganic particles but does not dissolve the polyimide precursor or the polyimide (this liquid may be hereinafter referred to as a “particle removing solution”). The particle removing solution is selected according so the type of inorganic particles used. Examples of the particle removing solution include: aqueous solutions of acids such as hydrofluoric acid, hydrochloric acid, hydrobromic acid, boric acid, perchloric acid, phosphoric acid, sulfuric acid, nitric acid, acetic acid, trifluoroacetic acid, and citric acid; and aqueous solutions of bases such as sodium hydroxide, potassium, hydroxide, tetramethylammonium hydroxide, sodium carbonate, potassium carbonate, ammonia, and the organic amines described above. Depending on the type of inorganic particles used and the type of polyimide precursor used, only water may be used as the particle removing solution.

### —Imidization—

The heating for imidizing the polyimide precursor in the film in the second step may be, for example, heating in two or more stages. Specifically, for example, the following heating conditions are used.

The heating conditions in the first stage are as follows. The heating temperature in the first stage may be set such that the shape of the particles is maintained. The heating temperature may be in the range of from 50° C. to 150° C. inclusive and is preferably in the range of from 60° C. to 140° C. inclusive. The heating time in the first stage may be in the range of from 10 minutes to 60 minutes inclusive. The higher the heating temperature in the first stage, the shorter the heating time in the first stage.

The heating conditions in the second stage may be, for example, a temperature of from 150° C. to 450° C. inclusive (preferably from 200° C. to 400° C. inclusive) for from 20 minutes to 120 minutes inclusive. When. the heating conditions are in the above ranges, the imidization reaction. further proceeds. During the heating reaction, the temperature may be increased stepwise or gradually at a constant rate before the temperature reaches the final heating temperature.

The heating conditions are not limited to those in the two-stage heating method described above, and a single-stage heating method, for example, may be used. In the single-stage heating method, the imidization may be completed, for example, only under the heating conditions in the second stage described above.

When the porous polyimide film is used alone, the polyimide film forming substrate used in the first step may be removed in the second step when the coating is dried and the film is obtained, when the polyimide precursor in the polyimide film becomes difficult to dissolve in the organic solvent, or when the imidization in the film is completed.

The porous polyimide film is obtained through the above steps. The porous polyimide film may be further processed according to its intended application.

The polyimide precursor solution used in the present exemplary embodiment may be subjected to defoaming treatment before the coating of the polyimide precursor solution is formed. The defoaming treatment may be performed because the occurrence of defects in the porous polyimide film obtained is reduced as compared to that when the defoaming treatment is not performed.

No particular limitation is imposed on the defoaming treatment method, and the defoaming treatment may be performed under reduced pressure (vacuum deforming) or may be performed under normal pressure. When the defoaming treatment is performed under normal pressure, the defoaming treatment may be performed while, for example, centrifugal force is applied by rotation or revolution. Even when the defoaming is performed under either reduced pressure or normal pressure, the defoaming treatment may be performed under stirring, heating, etc. as needed. The defoaming treatment may be performed under reduced pressure because the treatment can be performed easily and the defoaming ability is high. The conditions for the defoaming treatment may be set according to the amount of remaining pores.

### —Imidization Ratio—

The imidization ratio of the polyimide precursor will be described.

Examples of a partially imidized polyimide precursor include precursors having structures including units represented by the following general formulas (I-1), (I-2), and (I-3).

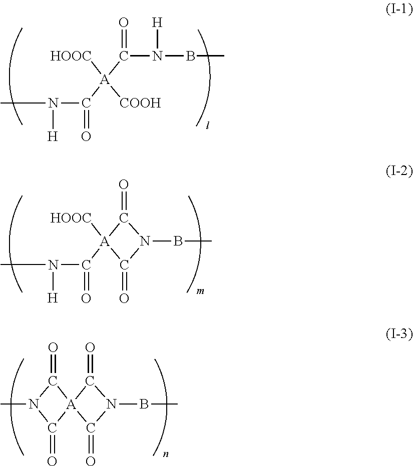

In general formulas (I-1), (I-2), and (I-3), A represents a tetravalent organic group, and B represents a divalent organic group. l represents an integer of 1 or lager, and m and. n each independently represent an integer of 0 or 1.

A and B in general formulas (I-1), (I-2), and (I-3) are the same as A and B in general formula (I) described above.

The polyimide precursor has bonding portions (reaction portions of the tetracarboxylic dianhydride and the diamine compound), and the imidization ratio of the polyimide precursor is the ratio of the number of bonding portions forming closed imide rings (2n+m) to the total number of bonding portions (2l+2m+2n). Specifically, the imidization ratio of the polyimide precursor is represented by “(2n+m)/(2l+2m+2n).”

The imidization ratio of the polyimide precursor (the value of “(2n+m)/(2l+2m+2n)”) is measured by the following method.

### —Measurement of Imidization Ratio of Polyimide Precursor—

### —Production of Polyimide Precursor Sample

(i) The polyimide precursor solution used for the measurement is applied to a silicone wafer to a thickness of from 1 μm to 10 μm inclusive to produce a coating sample.

(ii) The coating sample is immersed in tetrahydrofuran (THF) for 20 minutes to replace the solvent in the coating sample with tetrahydrofuran (THF). The solvent for immersion is not limited to TSP and is selected from solvents that do not dissolve the polyimide precursor and can be miscible with the solvent component contained in the polyimide precursor solution. Specifically, an alcohol solvent such as methanol or ethanol or an ether compound such as dioxane is used.

(iii) The coating sample is removed from the THF, and N₂ gas is blown onto the THF adhering to the surface of the coating sample to remove the THF. The coating sample is treated at a reduced pressure of 10 mmHg or lower in the temperature range of from 5° C. to 25° C. inclusive for 12 hours or longer co dry the coating sample, and a polyimide precursor sample is thereby produced.

### —Production of 100% Imidized Standard Sample

(iv) The polyimide precursor solution used for the measurement is applied to a silicone wafer as in (i) above to produce a coating sample.

(v) The coating sample is heated at 380° C. for 60 minutes to allow the imidization reaction to proceed, and a 100% imidized standard sample is thereby produced.

### —Measurement and Analysis

(vi) A Fourier transform infrared spectrophotometer (FT-730 manufactured by HORIBA Ltd.) is used to measure the infrared absorption spectrum of each of the 100% imidized standard sample and the polyimide precursor sample. For the 100% imidized standard sample, the ratio I′(100) of the absorption peak (Ab′ (1.780 cm⁻¹)) derived from imide bonds near 1780 cm⁻¹ to the absorption peak (Ab′(1500 cm⁻¹)) derived from aromatic rings near 1500 cm⁻¹ is determined.

(vii) Similarly, for the polyimide precursor sample, the ratio I(x) of the absorption peak (Ab′(1780 cm⁻¹)) derived from imide bonds near 1780 cm⁻¹ to the absorption peak (Ab′(1500 cm⁻¹)) derived from aromatic rings near 1500 cm⁻¹ is determined.

Then the measured absorption peak ratios I′(100) and I(x) are used to compute the imidization ratio of the polyimide precursor using the following formulas.

Formula: Imidization ratio of polyimide precursor=I(x)/I′(100)

Formula: I′(100)=(Ab′(1780 cm⁻¹))/(Ab′(1500 cm⁻¹))

Formula: I(x)=(Ab(1780 cm⁻¹))/(Ab(1500 cm⁻¹))

The above measurement of the imidization ratio of the polyimide precursor is applied to the measurement of the imidization ratio of an aromatic polyimide precursor. When the imidization ratio of an aliphatic polyimide precursor is measured, the peak derived from a structure that remains unchanged after the imidization reaction is used as an internal standard peak instead of the absorption peak of aromatic rings.

### <Properties of Porous Polyimide Film>

### (Pores)

No particular imitation is imposed on the porosity of the porous polyimide film. The porosity of the porous polyimide film is preferably from 45% by volume to 70% by volume inclusive, more preferably from 50% by volume to 70% by volume inclusive, still more preferably from 52% by volume to 68% by volume inclusive, and particularly preferably from 55% by volume to 65% by volume inclusive. When the porosity of the porous polyimide film is in the above range, the dielectric constant of the porous polyimide film may be lower than when the porosity is below the above range, and the mechanical strength of the porous polyimide film may be higher than when the porosity is beyond the above range.

The porosity of the porous polyimide film is determined from its apparent density and true density.

The apparent density d is a value obtained by dividing the mass (g) of the porous polyimide film by the volume (cm³) of the porous polyimide film including the pores. The apparent density d may be determined by dividing the mass per unit area (g/m²) of the porous polyimide film by the thickness (μm) of the porous polyimide film.

The true density ρ is a value obtained by dividing the mass (g) of the porous polyimide film by the volume (cm) of the porous polyimide film excluding the volume of the pores (i.e., the volume of only the resin skeleton).

The porosity of the porous polyimide film is computed using the following formula (II).

Porosity (% by volume)={1−(d/ρ)}×100=[1−{(w/t)/ρ)}]×100 Formula (II)

d: Apparent density of the porous polyimide film (q/cm³)

ρ: True density of the porous polyimide film (g/cm³)

w: Mass per unit area of the porous polyimide film (g/m²)

t: Thickness of the porous polyimide film (μm)

The pores may have a spherical shape or a shape close to a sphere. The pores may be connected to each other to form a connected shape.

No particular limitation is imposed on the average value of the diameters of the pores. The average pore diameter may be in the range of from 0.1 μm to 0.5 μm inclusive and is preferably in the range of from 0.25 μm to 0.48 μm inclusive and more preferably in the range of from 0.25 μm to 0.45 μm inclusive.

The average pore diameter is a value obtained by observation and measurement using a scanning electron microscope (SEM). Specifically, first, the porous polyimide film is cut in the thickness direction to prepare a measurement sample whose cross section serves as a measurement surface. Then the measurement sample is observed using a VE SEM manufactured by KEYENCE CORPORATION and subjected to measurement using image processing software provided as standard software of the SEM. The observation and measurement are performed for 100 pore portions in the cross section of the measurement sample. The pore diameter distribution is determined, and the average of the pore diameters is determined to thereby determine the average pore diameter. When the shape of the pores is not circular, the lengths of the longest portions of the pores are used as pore diameters.

### (Film Thickness)

No particular limitation is imposed on the average thickness of the porous polyimide film, and the average thickness may be selected according to its intended application.

The average thickness of the porous polyimide film may be, for example, from 10 μm to 1000 μm inclusive. The average thickness of the porous polyimide film may be 20 μm or more and may be 30 μm or more. The average thickness of the porous polyimide film may be 500 μm or less and may be 400 μm or less.

For example, when the porous polyimide film is used as an insulating coating that is a coating film of an insulated wire described later, the average thickness of the porous polyimide film. is preferably from 5 μm to 200 μm inclusive, more preferably from 7 μm to 150 μm inclusive, and still more preferably from 10 μm to 100 μm inclusive, from the viewpoint of maintaining sufficient insulation and preventing the volume efficiency of the insulated wire from deteriorating.

The average thickness of the porous polyimide film is determined as follows. The thickness of the porous polyimide film is measured at five points using an eddy current coating thickness meter CTR-1500E manufactured by SANKO ELECTRONIC LABORATORY CO., LTD., and the arithmetic mean of the measurements is computed.

### (Dielectric Constant)

No particular limitation is imposed on the relative dielectric constant of the porous polyimide film at 1 kHz. For example, when the porous polyimide film is used as the insulating coating that is the coating film of the insulated wire described later, the relative dielectric constant of the porous polyimide at 1 kHz is preferably 2.5 or less, more preferably 2.3 or less, and more preferably 2.1 or less, from the viewpoint of increasing the corona discharge start voltage of the wire. No particular limitation is imposed on the lower limit of the relative dielectric constant. However, the relative dielectric constant may be larger than 1, which is the relative dielectric constant of air.

The relative dielectric constant at 1 kHz is measured as follows. An LCR meter (ZM2353 manufactured by NF Corporation) is used to measure the electrostatic capacitance of the porous polyimide film when an AC electric field of 1 V and 1 kHz is applied to the porous polyimide film, and the relative dielectric constant is computed from the results of the measurement using a formula below. Tn the formula below, ϵᵣ is the relative dielectric constant, and s is the djelectric constant. C is the electrostatic capacitance, and l is the thickness. A is the area of electrodes during the measurement of the electrostatic capacitance, and ϵ₀ is the dielectric constant of a vacuum.

$${ε}_{r} = \frac{ε}{{ε}_{0}} = \frac{Cl}{A {ε}_{0}}$$

### <Applications of Porous Polyimide Film>

Examples of the applications of the porous polyimide film include: insulating coatings used as coating films of insulated wires described later; cell separators of lithium batteries etc separators for electrolytic capacitors; electrolyte films for fuel cells etc.; electrode materials for batteries; separation membranes for gas or liquid; low-dielectric constant materials; and filtration films.

### [Insulated Wire]

An insulated wire according to an exemplary embodiment includes a wire body and the above-described porous polyimide film disposed on the surface of the wire body in the insulated wire according to the present exemplary embodiment, the above-described porous polyimide film is used as an insulating coating that is a coating film coating the wire body.

Examples of the wire body include wires, rods, and plates made of metals and alloys such as annealed copper, hard-drawn copper, oxygen-free copper, chromium ore, aluminum, aluminum alloys, nickel, silver, soft iron, steel, and stainless steel. The wire body may be a stranded wire produced by twisting a plurality of wires.

No particular limitation is imposed on the thickness of the wire body, and the thickness may be, for example, in the range of from 0.1 mm to 5.0 mm inclusive. The thickness of the wire body is its major axis in a cross section perpendicular to the longitudinal direction of the wire body.

The porous polyimide film is disposed, for example, so as to surround the outer circumferential surface of the wire body. The porous polyimide film may cover the entire outer circumferential surface of the wire body or may cover part of the outer circumferential surface of the wire body.

The porous polyimide film may be disposed in contact with the surface of the wire body or may be disposed. thereon with an additional layer therebetween. The additional layer that may be disposed between the wire body and the dielectric polyimide film is, for example, an inner semiconductor layer.

An additional layer may be disposed on the outer circumferential surface of the porous polyimide film. The additional layer that may be disposed on the outer circumferential surface of the porous polyimide film may be, for example, an outer semiconductor layer.

The porous polyimide film used as the insulating coating may be formed by applying the above-described polyimide precursor solution so the outer circumferential surface of the wire body, drying the polyimide precursor solution, imidizing the polyimide precursor, and removing the particles. Alternatively, the insulating coating may be formed as follows. A film obtained by applying the polyimide precursor solution to the surface of the polyimide film forming substrate and drying the polyimide precursor solution, a polyimide film obtained by firing the film to imidize the polyimide precursor, or a polyimide film obtained by firing the film to imidize the polyimide precursor and remove the particles is peeled off from the polyimide film forming substrate, placed on the outer circumferential surface of the wire body, and optionally subjected to heating etc.

### EXAMPLES

Examples will next be described. However, the present disclosure is not limited. to these Examples. In the following description, “parts” and “%” are based on mass, unless otherwise specified.

### [Preparation of Resin Particle Dispersions]

### —Resin Particle Dispersion (1)—

360 Parts by mass of styrene, 11.9 parts by mass of a surfactant Dowfax 2A1 (17 mass % solution, Dow Chemical Company), and 150 parts by mass of deionized water are mixed and stirred at 1,500 rpm for 30 minutes using a dissolver to emulsify the mixture to thereby produce a monomer emulsion. Next, 0.9 parts by mass of Dowfax 2A1 (47 mass % solution, Dow Chemical Company) and 446.8 parts by mass of deionized water are added to a reaction vessel. The mixture is heated to 75° C. in a nitrogen flow, and. then 24 parts by Mass of the monomer emulsion is added thereto. Then a polymerization initiator solution prepared by dissolving 5.4 parts by mass of ammonium persulfate in 25 parts by mass of deionized water is added dropwise over 10 minutes. After completion of the dropwise addition, the mixture is allowed to react for 50 minutes, and the rest of the monomer emulsion is added dropwise over 180 minutes. The resulting mixture is allowed to react for 180 minutes and cooled to obtain a resin particle dispersion (1). The solid concentration of the resin particle dispersion (1) is 36.0% by mass, The volume average particle diameter of the resin particles is 0.38 μm.

### [Preparation of Polyimide Precursor-Containing Solution]

### —Polyimide Precursor-Containing Solution (A)—

560.0 Parts by mass of ion exchanged water is heated to 50° C. in a nitrogen flow, and 53.75 parts by mass (50 parts by mole) of p-phenylenediamine and 146.25 parts by mass (50 parts by mole) of 3,3′,4,4′-biphenyltetracarboxylic dianhydride are added under stirring. A mixture of 150.84 parts by mass (150 parts by mole) of N-methylmorpholine (hereinafter referred to also as “MMO”) and 89.16 parts by mass of ion exchanged water is added at 50° C. in a nitrogen flow over 20 minutes under stirring, The mixture is allowed to react at 50° C. for 15 hours to thereby obtain a polyimide precursor-containing solution W. The solid concentration of the polyimide precursor-containing solution (A) is 20.0% by mass.

### Example 1

### Preparation of Resin, Particles-Dispersed Polyimide Precursor Solution (PAA-1)

289.65 Parts by mass of the polyimide precursor-containing solution (A), 172.41 parts by mass of the resin particle dispersion (1), and 137.94 parts by mass of a water-based solvent (a solution mixture of NMP and water, mass ratio=30.41:107.53) are mixed. The mixture is subjected to ultrasonic dispersion at 50° C. for 30 minutes. 0.37 Parts by mass (0.14 parts by mole) of pyromellitic acid used as the specific compound serving as a crosslinking agent is added to the resulting mixture to thereby obtain a polyimide precursor solution (PAA-1).

The weight average molecular weight of the polyimide precursor (A1) contained in the polyimide precursor solution (PAA-1) is 30000.

The content of the resin particles (“Content of particles (% by volume)” in Table 1) based on the total amount of The polyimide precursor and the particles is measured by the method described above, and the results are shown in Table 1. The content of the specific compound (“Content ratio (parts by mole)” in Table 1) based on 100 parts by mole of the unit derived from the tetracarboxylic dianhydride contained in the polyimide precursor is shown in Table 1.

### Examples 2 to 7

Polyimide precursor solutions (PAA-2) to (PAA-7) are obtained in the same manner as in Example 1 except that the content of the particles (“Content of particles (% by volume)” in Table 1) based on the total amount of the polyimide precursor and the particles, the type of specific compound (“Type” in Table 1), and the content of the specific compound (“Content ratio (parts by mole)” in Table 1) based on 100 parts by mole of the unit derived from the tetracarboxylic dianhydride contained in the polyimide precursor are changed as shown in Table 1.

In Table 1, specific compounds 1 to 4 mean the following compounds.

Specific compound 1: pyromellitic acid

Specific compound 2: 1,4,5,8-naphthalenetetracarboxylic acid

Specific compound 3: 1,2,3,4-cyclobutanetetracarboxylic acid

Specific compound 4: 3,3′,4,4′-benzophenonetetracarboxylic acid

### Comparative Example 1

A polyimide precursor solution (PAA-8) is obtained in the same manner as in Example 1 except that the specific compound is not used.

In Table 1, “-” means that no component is added.

### Comparative Example 2

A polyimide precursor solution (PAA-9) is obtained in the same manner as in Example 1 except that 7.1 parts by mass (0.14 parts by mole) of a water-based urethane resin (product name: ELASTRON BN-P17 manufactured by DAI-ICHI KOGvO SETYAKU Co., Ltd.) is used as a crosslinking agent instead of the specific compound.

### <Evaluation>

The polyimide precursor solutions obtained in the Examples are used to produce porous polyimide films.

### (Production of Porous Polyimide Films)

One of the polyimide precursor solutions obtained in the Examples is applied to a 10 cm×10 cm area of a glass substrate having a thickness of 1.0 mm using an applicator and dried in an oven at 80° C. for 30 minutes to thereby obtain a film. A gap of the applicator is adjusted such that the average thickness of the dried film is 30 μm.

The glass substrate with the film formed. thereon. is left to stand in an oven heated to 400° C. for 2 hours to fire the film and then immersed in ion exchanged water. The fired film is separated from the glass substrate and dried to thereby obtain a porous polyimide film.

### (Measurement of Porosity)

The porosity (% by volume) of each of the porous polyimide films obtained is measured by the method described above, and the results are also shown in Table 1.

### (Measurement of Dielectric Constant)

The relative dielectric constant of each of the porous polyimide films obtained is measured by the method described above. The results are shown in Table 1.

### (Evaluation of Tensile Strength)

The tensile strength of each of the porous polyimide films at. 25° C. is measured. using a tensile tester (STROGRAPH VI-C manufactured by Toyo Seiki Seisaku-sho, Ltd.) and evaluated according to the following criteria. The results are shown in Table 1.

### —Evaluation Criteria—

A: The tensile strength is 80 MPa or more.

B: The tensile strength is 60 MPa or more and less than 80 MPa.

C: The tensile strength is less than 60 MPa.

### (Evaluation of Bending Resistance)

Each of the porous polyimide films obtained is mountain-folded in half. A load of 500 g is applied to the fold line, and the resulting porous polyimide film is left to stand for 24 hours. Then the load is removed, and the folded portion is visually checked and evaluated according to the following criteria. The results are shown in Table 1.

### —Evaluation Criteria—

A: A fold mark is formed, but no breakage of the film is found.

B: A fold mark is formed, and cracking of the film is found in part of the folded portion.

C: The film is broken at the folded portion.

TABLE 1

| | | Crosslinking agent | | | | | |
|---|---|---|---|---|---|---|---|
| | Content of | | Content | Measurement and evaluation | | | |
| | particles (% | | ratio (parts | Porosity (% | Dielectric | Tensile | Bending |
| | by volume) | Type | by mole) | by volume) | constant | strength | resistance |
| Example 1 | 60 | Specific | 0.5 | 58 | 1.8 | A | A |
| | | compound 1 | | | | | |
| Example 2 | 60 | Specific | 1.0 | 57 | 1.8 | A | A |
| | | compound 1 | | | | | |
| Example 3 | 60 | Specific | 1.0 | 57 | 1.8 | A | A |
| | | compound 2 | | | | | |
| Example 4 | 60 | Specific | 1.0 | 58 | 1.8 | A | A |
| | | compound 3 | | | | | |
| Example 5 | 60 | Specific | 1.0 | 58 | 1.8 | A | A |
| | | compound 4 | | | | | |
| Example 6 | 60 | Specific | 1.8 | 57 | 1.8 | A | A |
| | | compound 1 | | | | | |
| Example 7 | 50 | Specific | 1.0 | 48 | 2.0 | A | A |
| | | compound 1 | | | | | |
| Comparative | 60 | — | 0 | 58 | 1.8 | B | B |
| Example 1 | | | | | | | |
| Comparative | 60 | Water-based | 1.0 | 58 | 1.8 | C | C |
| Example 2 | | urethane resin | | | | | |

As can be seen from the results shown in Table 1, the porous polyimide films produced using the polyimide precursor solutions obtained in the Examples have both a lower dielectric constant and higher mechanical strength than the porous polyimide films produced using the polyimide precursor solutions obtained in the Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A polyimide precursor solution comprising:
a polyimide precursor that is a polymer of a tetracarboxylic dianhydride and a diamine compound;
particles;
a solvent; and
a compound having at least four carboxy groups per molecule.

2. The polyimide precursor solution according to claim 1, wherein a content of the compound having at least four carboxy groups per molecule is from 0.3 parts by mole to 2.0 parts by mole inclusive based on 100 parts by mole of the tetracarboxylic dianhydride.

3. The polyimide precursor solution according to claim 2, wherein the content of the compound having at least four carboxy groups per molecule is from 0.5 parts by mole to 1.5 parts by mole inclusive based on 100 parts by mole of the tetracarboxylic dianhydride.

4. The polyimide precursor solution according to claim 1, wherein the compound having at least four carboxy groups per molecule is an aromatic tetracarboxylic acid.

5. The polyimide precursor solution according to claim 2, wherein the compound having at least four carboxy groups per molecule is an aromatic tetracarboxylic acid.

6. The polyimide precursor solution according to claim 3, wherein the compound having at least four carboxy groups per molecule is an aromatic tetracarboxylic acid.

7. The polyimide precursor solution according to claim 4, wherein a number of aromatic rings per molecule of the aromatic tetracarboxylic acid is 5 or less.

8. The polyimide precursor solution according to claim 5, wherein a number of aromatic rings per molecule of the aromatic tetracarboxylic acid is 5 or less.

9. The polyimide precursor solution according to claim 6, wherein a number of aromatic rings per molecule of the aromatic tetracarboxylic acid is 5 or less.

10. The polyimide precursor solution according to claim 1, wherein the polyimide precursor is a polymer of an aromatic tetracarboxylic dianhydride and an aromatic diamine compound.

11. The polyimide precursor solution according to claim 2, wherein the polyimide precursor is a polymer of an aromatic tetracarboxylic dianhydride and an aromatic diamine compound.

12. The polyimide precursor solution according to claim 3, wherein the polyimide precursor is a polymer of an aromatic tetracarboxylic dianhydride and an aromatic diamine compound.

13. The polyimide precursor solution according to claim 4, wherein the polyimide precursor is a polymer of an aromatic tetracarboxylic dianhydride and an aromatic diamine compound.

14. The polyimide precursor solution according to claim 1, wherein the particles are resin particles.

15. The polyimide precursor solution according to claim 1, wherein a volume content of the particles is from 50% by volume to 70% by volume inclusive based on a total volume of the polyimide precursor and the particles.

16. The polyimide precursor solution according to claim 1, wherein the solvent contains water.

17. The polyimide precursor solution according to claim 16, further comprising an organic amine compound.

18. A porous polyimide film, wherein the porous polyimide film is a porous fired product obtained from the polyimide precursor solution according to claim 1 and having pores.

19. The porous polyimide film according to claim 18, wherein the porous polyimide film has a porosity of from 50% by volume to 70% by volume inclusive.

20. An insulated wire comprising:
a wire body; and
the porous polyimide film according to claim 18, the porous polyimide film being disposed on a surface of the wire body.
